(19) United States
(12) Patent Application Publication
(10) Pub. No.: US 2003/0089685 A1
(43) Pub. Date: May 15, 2003

(54) Electronic beam drawing apparatus, method of regulating electronic beam drawing apparatus, and electronic beam drawing method

(76) Inventor: Atsushi Ando, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/285,453

(22) Filed: Nov. 1, 2002

(30) Foreign Application Priority Data
Nov. 2, 2001 (JP) 2001-337760

(51) Int. Cl. B23K 15/00

(52) U.S. Cl. 219/121.12

(57) ABSTRACT

In an optical system in which a shaping aperture is illuminated by an illuminating optical system composed of an asymmetric lens system and in which an aperture image obtained is projected by a projecting optical system so as to be contracted, if a plane perpendicular to an optical axis is called an XY plane, a crossover between the optical axis and an X or Y track of an electron beam emitted by an electron gun is located above the shaping aperture, while a crossover between the optical axis and the Y or X track of the beam is located below the shaping aperture. The illuminating optical system is regulated so that these vertical positions are at an equal distance from the shaping aperture and so that the projecting magnification of the beam from the electron gun is the same at both crossovers.

### CROSS-REFERENCE TO RELATED APPLICATIONS

This application is based upon and claims the benefit of priority from the prior Japanese Patent Application No. 2001-337760, filed Nov. 2, 2001, the entire contents of which are incorporated herein by reference.

### BACKGROUND OF THE INVENTION

1. Field of the Invention

The present invention relates to an electron beam drawing apparatus that uses an electron beam to form a semiconductor integrated circuit or other fine device patterns on a substrate such as a semiconductor wafer or a pattern transfer mask.

2. Description of the Related Art

An optical lithography technology for semiconductor manufacture processes has widely been used to produce devices owing to its advantages such as simplified processes and reduced costs. Attempts are always made to improve this technology. In recent years, a shorter wavelength (a KrF excimer laser light source) has been introduced, so that very small devices of size 0.25 μm or less are likely to be provided. To further reduce the size of the devices, efforts are being made to develop an ArF excimer laser light source with a reduced wavelength and a Levenson type phase shift mask. Such a light source or phase shift mask is used as a mass production lithography tool compatible with a 0.15 μm rule.

However, many problems must be solved before such a light source or phase shift mask can be actualized. Further, efforts have already been made for development for a very long time. Thus, the development may fail to catch up with the size reduction of the devices. In this regard, electron beam lithography, a first candidate for post optical lithography, has proven to attain a high resolution of the order of 0.01 μm using a thinned beam. This technique seems to have no problems in terms of size reduction, but as a device mass production tool, is problematic in terms of throughput. That is, the electron beam lithography requires much time because it comprises sequentially drawing fine patterns one by one. To reduce the drawing time, a partial batch exposure method, i.e. a CP (character projection) drawing method has been developed in which repeated portions of a ULSI pattern are partly and collectively drawn.

Furthermore, to improve the throughput of a drawing apparatus, it is important to reduce exposure time. The exposure time is expressed by the following equation:

t(sec)=D(C/cm²)/J(A/cm²) (1)

where t is the exposure time, D is an appropriate dose, and J is a current density.

To reduce the exposure time, it is effective to improve resist sensitivity. A method for improving the resist sensitivity is to improve the characteristics of the resist itself. However, it is difficult to simultaneously achieve an increase in the sensitivity of the resist and a resolution of 0.1 μm or less. As a result, the current practical resist sensitivity is about 10 μC/cm² at a mass production level.

On the other hand, the resist sensitivity is in inverse proportion to the energy of an incident electron beam. For example, when the energy of the incident electron beam is 50 keV, a resist of sensitivity 10 μC/cm² has its sensitivity reduced down to 0.2 μC/cm² by increasing the energy of the incident electron beam up to 1 keV. That is, shot time decreases to improve the throughput.

Another method for reducing the exposure time is to increase the current density of a beam. However, an increase in current density corresponds to an increase in current value used for exposure. An increase in current increases the amount of beam blurs as a result of repulsion of the beam caused by the Coulomb effect. This precludes fine patterns from being drawn. Thus, the patterns are currently drawn using such a current value that the amount of beam blurs is equal to or smaller than a specified value.

Attempts to weaken the Coulomb effect include the techniques described in Jpn. Pat. Appln. KOKAI Publication Nos. 2001-102295 and 2002-50567. To weaken the Coulomb effect, the techniques described in these documents are configured so that a CP (Character Projection) aperture is isotropically illuminated by an illuminating optical system composed of an asymmetric lens system using a rectangular cathode having a finite aspect ratio and so that the CP aperture image obtained is projected so as to be contracted, by a projecting optical system composed of an asymmetric lens system. Thus, an image is formed on a sample surface with the angle of aperture which is different from the incident angle. FIG. 1 shows a conventional electron beam drawing apparatus comprising an asymmetric light source in the above manner.

That is, a linear cathode has hitherto been used which has different shapes in the directions of an X and Y axes. With such an arrangement, an asymmetric illuminating optical system 146 achieves different magnifications on an X track 104 and on a Y track 105 of an electron beam. Furthermore, the beam is isotropically applied to a shaping aperture that shapes the electron beam, in this case, a CP aperture 119. In FIG. 1, the CP aperture image obtained is projected so as to be contracted, by a projecting optical system composed of an asymmetric lens system. Then, an image forming optical system 147 forms an image on a sample surface.

In such a conventional electron beam drawing apparatus having an asymmetric light source, electrons emitted by the rectangular cathode having the finite aspect ratio (the ratio of the length of the cathode 103 in the X direction to its length in the Y direction), i.e. an electron gun must be asymmetric. This has been realized with an LaB₆ electrode but not with an field emission type electron gun having a small emitted energy distribution. The LaB₆ electron gun is said to have an energy spread of about 3 eV, which is larger than that of the field emission type electron gun, 0.6 eV. Thus, the emitted energy distribution may vary to increase the level of chromatic aberration, resulting in beam blurs.

### BRIEF SUMMARY OF THE INVENTION

According to an aspect of the invention, there is provided an electron beam drawing apparatus in which to reduce the Coulomb effect, a CP aperture is illuminated by an illuminating optical system composed of an asymmetric lens system and in which a CPU aperture image obtained is projected by a projecting optical system so as to be contracted, the apparatus being characterized in that if a plane perpendicular to an optical axis is called an XY plane, a crossover between the optical axis and an X track of a beam isotropically emitted by an electron gun is located above the CP aperture, while a crossover between the optical axis and a Y track of the beam is located below the CP aperture. In particular, the quadrupole asymmetric illuminating optical system is regulated so that these vertical positions are at an equal distance from the CP aperture and so that the projecting magnification of the beam from the electron gun is the same at both crossovers.

According to an aspect of the invention, there is provided a regulating method applied to an electron beam drawing apparatus comprising an asymmetric illuminating optical system which sets an electron beam emitted by an electron beam source to be applied to a desired illumination area at a desired current density, a shaping aperture which shapes the electron beam into any form, and a reducing lens and an objective lens to form the shaped electron beam into an image on a sample. Lens set values are calculated so that a crossover between an X track and an optical axis is located above the shaping aperture, while a crossover between a Y track and the optical axis is located below the shaping aperture and so that a distance from the shaping aperture to the crossover between the X track and the optical axis is equal to a distance from the shaping aperture to the crossover between the Y track and the optical axis. Lenses of the asymmetric illuminating optical system are set on the basis of the lens set values. Lens values are determined using means for determining an area of the shaping aperture which is irradiated with an electron beam and means for determining the angle of aperture of an electron beam applied to the shaping aperture. The determined lens values are fine-tuned to set the asymmetric illuminating optical system.

According to an aspect of the invention, there is provided a drawing method comprising a step of setting lenses of an illuminating optical system of an electron beam drawing apparatus to have predetermined lens set values using the above adjusting method, a step of placing a semiconductor wafer the surface of which is coated with a resist, on the electron beam drawing apparatus set to have the predetermined lens set value, and a step of irradiating the resist applied to the semiconductor wafer placed in the apparatus, with an electron beam from the electron beam drawing apparatus in a predetermined pattern.

### BRIEF DESCRIPTION OF THE SEVERAL VIEWS OF THE DRAWING

FIG. 1 is a schematic diagram showing a conventional illuminating optical system;

FIG. 2 is a schematic diagram showing an electron beam drawing apparatus according to a first embodiment of the present invention;

FIG. 3 is a schematic diagram showing an illuminating optical system according to the first embodiment and a second embodiment of the present invention;

FIG. 4 is a schematic diagram showing an electron beam drawing apparatus according to the second embodiment of the present invention; and

FIG. 5 is a characteristic diagram illustrating resolution.

### DETAILED DESCRIPTION OF THE INVENTION

With reference to the drawings, description will be given below of an electron beam drawing apparatus, a method of regulating an electron beam drawing apparatus, and an electron beam drawing method.

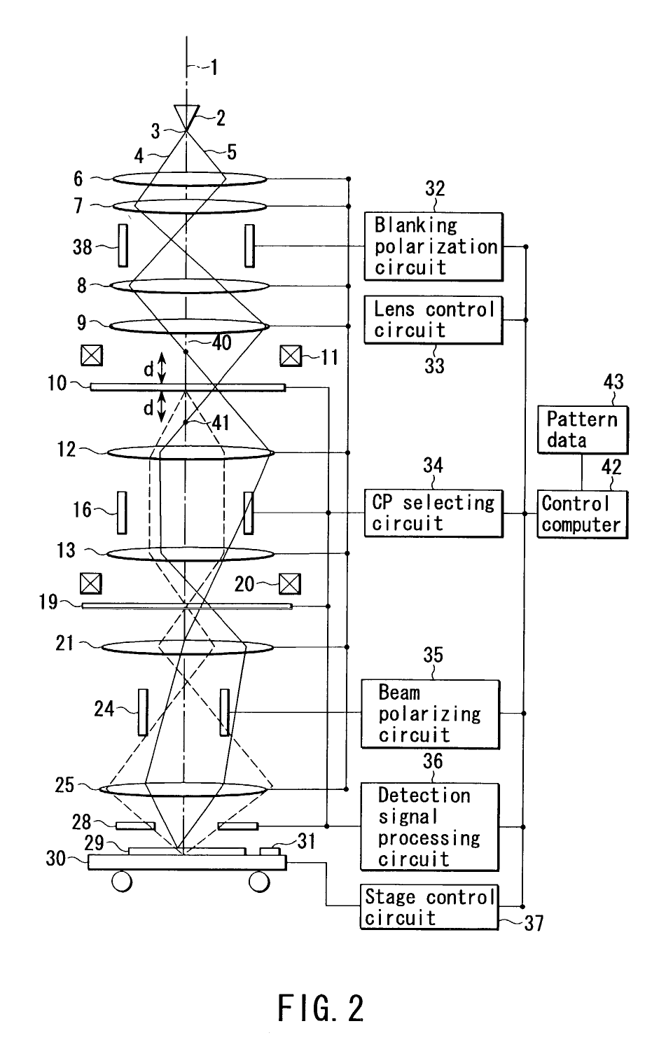

First, the first embodiment will be described with reference to FIGS. 2 and 3.

FIG. 2 is a basic schematic sectional view of the electron beam drawing apparatus. This embodiment uses two shaping apparatuses consisting of a first and second shaping apertures (the second shaping aperture is of a CP type).

The electron beam drawing apparatus comprises an electron gun 2 as an electron beam source, asymmetric illuminating optical system lenses that set an electron beam 3 generated by the electron gun 2 to be applied to a desired illuminated area at a desired current density, a first shaping aperture 10 and a second shaping aperture (CP aperture) 19 which shape the electron beam 3 into any form, projecting lenses that project an aperture image of the first shaping aperture 10 on the second shaping aperture 19, a reducing lens that forms the electron beam shaped by the first and second shaping apertures, into an image on a sample, and an objective lens that forms the shaped electron beam passed through the reducing lens, into an image on the sample. An optical axis 1 of the electron beam is formed in a direction in which the electron gun 2 emits the electron beam and in a central portion of a wafer 29 such as silicon placed on a stage 30.

A direction along the optical axis 1 is defined as Z. Directions perpendicular to the direction Z are defined as X and Y. The electron beam 3 will be described in terms of an X track 4 in an X direction and a Y track 5 in a Y direction. In this embodiment, the electronic lenses of the illuminating optical system are composed of, for example, quadrupole electrostatic lenses. However, the present invention is not limited to these lenses. These lenses are composed of four electrodes arranged in place and cause electrons to diverge in the X direction and converge in the Y direction. Electrons can be caused to converge in both X and Y directions by arranging two or more sets of four poles along the optical axis 1 and applying an appropriate electric field. Such a lens optical system is mainly characterized in that the X and Y tracks are asymmetric with respect to the optical axis 1.

The electron beam 3 isotropically emitted by the electron gun 2 advances along the X track 4 and the Y track 5, respectively, and has its current density adjusted by quadrupole lenses (CQL1;6, CQL2;7, CQL3;8, and CQL4;9) of the illuminating optical system to isotropically illuminate the first shaping aperture 10. An image shaped by the first shaping aperture 10 is formed on the CP aperture 19 by a projecting first lens (PLI) 12 and a projecting second lens (PL2) 13 constituting a projecting system. A CP polarizer 16 controls the level of the optical superimposition of the two apertures 10 and 19.

The polarizer 16 is driven by a CP selecting circuit 34 and a control computer 42 that transmits polarization data to a polarizing circuit. The first shaping aperture 10 and the CP aperture (second shaping aperture) 19 connect to a detector 28 and a detection signal processing circuit 36 connected to the detector. An image obtained by optically superimposing the first shaping aperture 10 on the CP aperture 19 is contracted by a reducing lens (RC) 21 and is formed on the wafer 29 by an objective lens (OL) 25.

The position of the electron beam 3 on the wafer 29 is set on the basis of polarization effected when the control computer 42 controls a beam polarizing circuit 35 and applies a voltage to an objective polarizer 24. The wafer 29 is installed on the movable stage 30 together with an electron beam measuring mark table 31. Moving the movable stage 30 allows either the wafer 29 or the mark table 31 to be selected.

Further, if the position of the electron beam 3 on the wafer 29 is moved, a blanking polarizer 38 polarizes and cuts the electron beam 3 so that it will not reach the surface of the wafer 29, in order to hinder undesired areas of the wafer from being exposed. A polarizing voltage applied to the blanking polarizer 38 is controlled by the control computer 42 and the blanking polarization circuit 32. All these data are stored as the pattern data 43.

This embodiment will be described while comparing the illuminating optical system of the electron beam drawing apparatus configured as described above, with the conventional example.

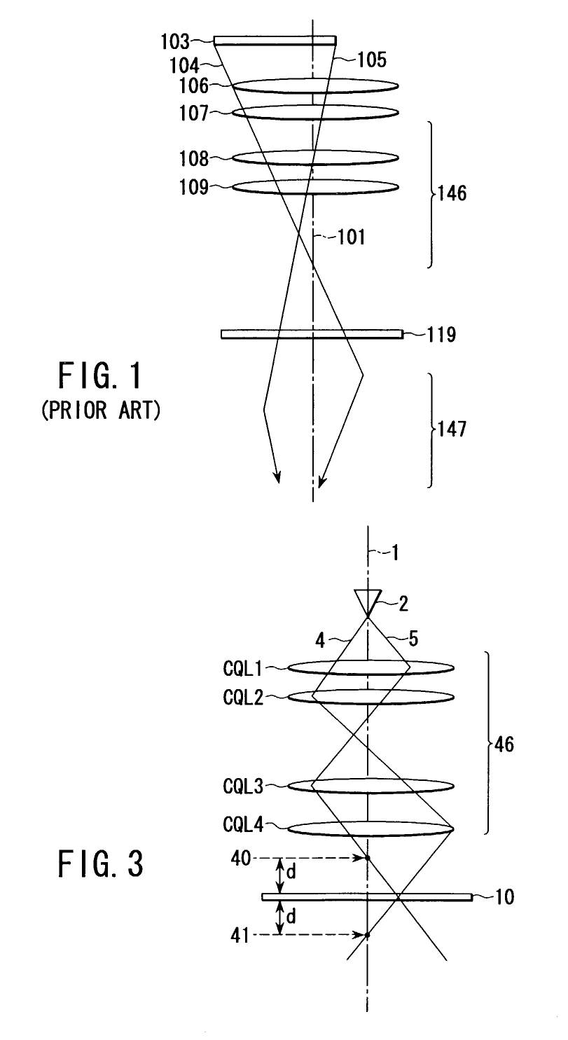

To reduce the amount of beam blurs resulting from the Coulomb effect, it is effective that in the image forming optical system, the incident angle of the X track of the electron beam differs from that of the Y track, as disclosed in the previously cited documents. To isotropically irradiate the CP aperture, which shapes the electron beam, with beams along the X and Y tracks, a linear cathode has hitherto been used which has different shapes in the X axis direction and in the Y axis direction, as shown in FIG. 1. With this arrangement, the asymmetric illuminating optical system 146 achieves different magnifications on the X track and on the Y track and allows the CP aperture, which shapes the beam, to be isotropically irradiated with the beam. This linear electrode has been realized with an electron gun made of LaB₆ or the like. However, because of its characteristics, the LaB₆ electron gun emits an electron beam 3 having a large energy distribution. With an electron line source with a large energy distribution, the level of chromatic aberration may increase to degrade resolution. Electron guns with small energy distributions include a field emission type. No linear type field emission electron guns have been realized yet.

FIG. 3 is a partial schematic diagram of the electron beam drawing apparatus illustrating the asymmetric illuminating optical system of this embodiment.

The X track 4 and Y track 5 of the electron beam 3 emitted by the electron gun 2 are symmetric. Subsequently, an asymmetric illuminating optical system 46 (CQL1;6, CQL2;7, CQL3;8, and CQL4;9) isotropically illuminates the first shaping aperture 10. The X track 4 and Y track 5 of the electron beam are configured so that at this time, the crossover between the X track 4 and the optical axis 1 (X crossover 40) is closer to the electron gun 2 relative to the first shaping aperture 10, while the crossover between the Y track 5 and the optical axis 1 (Y crossover 41) is closer to the wafer 29 relative to the first shaping aperture 10. Further, the tracks are adjusted so that the respective crossovers are at an equal distance (=d) from the shaping aperture 10 and so that the contraction rate of the electron beam from the electron gun 2 is equivalent at both crossovers.

The same positional relationship for the crossovers also applies to the second shaping aperture (CP aperture). That is, as shown in FIG. 2, the X track 4 and Y track 5 of the electron beam are configured so that the crossover between the X track 4 and the optical axis 1 (X crossover (not shown)) is closer to the electron gun 2 relative to the second shaping aperture 19, while the crossover between the Y track 5 and the optical axis 1 (Y crossover (not shown)) is closer to the wafer 29 relative to the second shaping aperture 19. Further, the tracks are adjusted so that the respective crossovers are at an equal distance from the second shaping aperture 19 and so that the contraction rate of the electron beam from the electron gun 2 is equivalent at both crossovers.

Now, an adjusting method will be specifically described.

The lenses 6, 7, and 8 of the asymmetric illumination system are set to have lens voltage values determined in designing the electronic optical system. The use of electrostatic lenses avoids hysteresis that may occur with lenses utilizing magnetic fields. Consequently, optical conditions are set so as to attain high reproducibility.

Then, a first shaping aperture alignment coil 11 is used to polarize and scan the electron beam 3 in the X and Y directions. At this time, the magnitude of the electron beam 3 applied to the first shaping aperture can be determined using, as a signal, electrons passing through the opening of the first shaping aperture 10, e.g. electrons flowing into the underlying CP aperture 19. The lenses of the asymmetric illuminating optical system are set so that at this time, an area irradiated with the electron beam 3 in the X direction is as large as an area irradiated with the electron beam 3 in the Y direction.

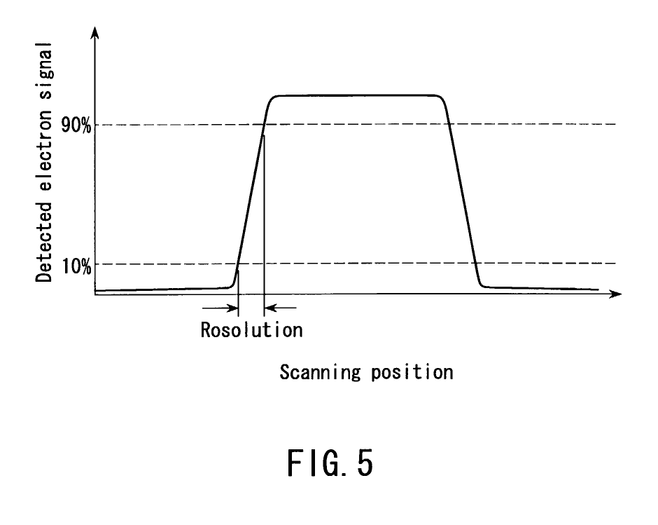

Then, the objective lens (OL) 25 is varied to vary the resolutions of X track 4 and Y track 5 of the electron beam. The resolutions are obtained by using the shaped electron beam 3 to scan a mark installed on the mark table 31, e.g. a dot of size about 0.2 μm which is made of tungsten and allowing the detector 28 such as an MCP to detect secondarily generated electrons. As shown in FIG. 5, at this time, the resolution is assumed to correspond to 10 to 90% of a peak of a signal waveform obtained, and the asymmetric illumination lenses are set so that the variation on the X track is the same as that on the Y track.

The optical system regulated as described above constitutes an asymmetric illuminating optical system before and after the first shaping aperture 10 but provides isotropic illumination on the first shaping aperture 10 in the X and Y directions. Further, the contraction rate for the light source of the electron gun 2 is set to be the same at the position of the X crossover 40 and at the position of the Y crossover 41. Accordingly, the angle between one of the crossovers and the first shaping aperture 10 is the same as the angle between the other crossover and the first shaping aperture 10. That is, the angle of aperture in the image forming optical system is the same on the X track and on the Y track. Subsequently, as shown in FIG. 2, an aperture image of the electron beam shaped by the first aperture 10 is formed on the CP aperture 19 at a contraction rate of 1 through the projecting lens system (PL1;12 and PL2;13), with the illumination conditions saved in the image. The X track 4 and Y track 5 of the electron beam 3 from the illuminating optical system advance asymmetrically through the reducing lens (RL) 21 and objective lens (OL) 25, located between the CP aperture 19 and the wafer 29, where beam blurs may be caused by the Coulomb effect. Consequently, no crossovers are created in the image forming optical system. Therefore, the effects of Coulomb repulsion can be weakened.

As described above, this embodiment is characterized in that the X crossover 40 between the optical axis 1 and the X track 4 of the electron beam 3 emitted by the electron gun 2 is located above the first shaping aperture 10, while the Y crossover 41 between the optical axis 1 and the Y track 5 of the electron beam 3 is located below the first shaping aperture 10 and in that in particular, the illuminating optical system is regulated so that the X and Y crossovers are located at the equal distance (d) from the shaping aperture 10 and so that the projecting magnification of the beam from the electron gun 2 is the same at both crossovers. Thus, an optical system is realized which enables an electron gun with a fixed aspect ratio to isotropically illuminate the CP aperture and which can weaken the Coulomb effect. As a result, a field emission electron gun can be used to reduce variations in emitted energy distribution and thus the amount of beam blurs caused by chromatic aberration. This serves to provide an electron beam drawing apparatus with a high resolution.

The beam resolution may also be determined as follows: The mark table 31 is movable in the vertical direction. Thus, variations in the resolutions of X track 4 and Y track 5 of the electron beam 3 are determined by moving the mark table 31 in the vertical direction from the position at which the resolution is lowest. For example, for the X direction, a variation in resolution is determined by moving the mark table 31 upward. For the Y direction, a variation in resolution is determined by moving the mark table 31 downward. The quadrupole electrostatic lenses of the asymmetric illuminating optical system may be regulated on the basis of the variations in resolutions.

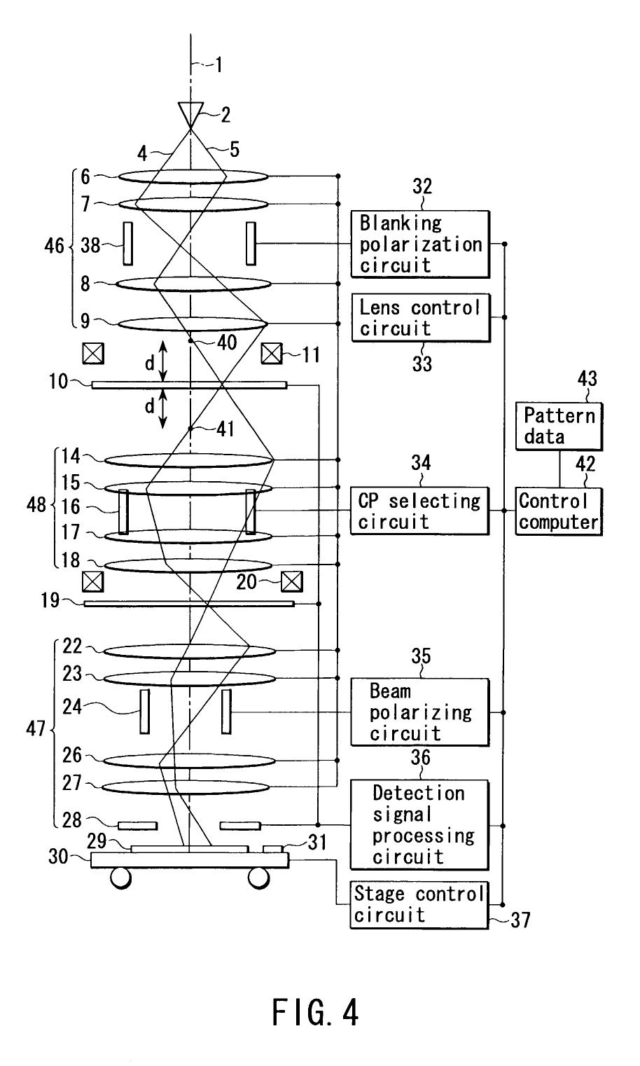

Now, a second embodiment will be described with reference to FIGS. 3 and 4.

FIG. 4 is a basic schematic sectional view of an electron beam drawing apparatus. This embodiment uses two shaping apertures consisting of a first and second shaping apertures (the second shaping aperture is of a CP type). This electron beam drawing apparatus comprises the electron gun 2, asymmetric illuminating optical system lenses that set the electron beam 3 generated by the electron gun 2 to be applied to a desired illuminated area at a desired current density, a first shaping aperture 10 and a second shaping aperture (CP aperture) 19 which shape the electron beam 3 into any form, a projecting optical system 48 that projects an aperture image of the first shaping aperture 10 on the second shaping aperture 19, and an image forming optical system 47 having a reducing lens that forms the electron beam shaped by the first and second shaping apertures, into an image on a sample and an objective lens that forms the shaped electron beam passed through the reducing lens, into an image on the sample. The optical axis 1 of the electron beam is formed in the direction in which the electron gun 2 emits the electron beam and in the central portion of the wafer 29 such as silicon placed on the stage 30.

The direction along the optical axis 1 is defined as Z. The directions perpendicular to the direction Z are defined as X and Y. The electron beam 3 will be described in terms of the X track 4 in the X direction and the Y track 5 in the Y direction. In this embodiment, the electronic lenses of the illuminating optical system are composed of, for example, quadrupole electrostatic lenses. These lenses are composed of four electrodes arranged in place and cause electrons to diverge in the X direction and converge in the Y direction. Electrons can be caused to converge in both X and Y directions by arranging two or more sets of four poles along the optical axis 1 and applying an appropriate electric field.

Such a lens optical system is mainly characterized in that the X and Y tracks are asymmetric with respect to the optical axis 1. The electron beam 3 isotropically emitted by the electron gun 2 advances along the X track 4 and the Y track 5, respectively, and has its current density adjusted by quadrupole lenses (CQL1;6, CQL2;7, CQL3;8, and CQL4;9) of the asymmetric illuminating optical system to isotropically illuminate the first shaping aperture 10. An image shaped by the first shaping aperture 10 is formed on the CP aperture (second shaping aperture) 19 by projecting quadrupole lenses (PQL1;14, PQL2;15, PQL3;17, and PQL4;18). The CP polarizer 16 controls the level of the optical superimposition of the two apertures 10 and 19. The polarizer 16 is driven by the CP selecting circuit 34 and the control computer 42 that transmits polarization data to the polarizing circuit.

An image obtained by optically superimposing the first shaping aperture 10 on the CP aperture 19 is contracted by reducing quadrupole lenses (RQL1;22 and RQL2;23) and is formed on the wafer 29 by objective quadrupole lenses (OQL;26 and OQL2;27). The position of the electron beam 3 on the wafer 29 is set on the basis of polarization effected when the control computer 42 controls the beam polarizing circuit 35 and applies a voltage to an objective polarizer 24. The wafer 29 is installed on the movable stage 30 together with the electron beam measuring mark table 31. Moving the movable stage 30 allows either the wafer 29 or the electron beam measuring mark table 31 to be selected. Further, if the position of the electron beam 3 on the wafer 29 is moved, the blanking polarizer 38 polarizes and cuts the electron beam 3 so that it will not reach the surface of the wafer 29, in order to hinder the undesired areas of the wafer from being exposed. The polarizing voltage applied to the blanking polarizer 38 is controlled by the control computer 42 and the blanking polarization circuit 32. All these data are stored as the pattern data 43. This embodiment will be described in terms of the illuminating optical system of the electron beam drawing apparatus configured as described above.

To reduce the amount of beam blurs resulting from the Coulomb effect, it is effective that in the image forming optical system, the incident angle of the X track of the electron beam differs from that of the Y track. To isotropically irradiate the CP aperture, which shapes the electron beam, with the X and Y tracks of the beam, a linear cathode has hitherto been used which has different shapes in the X axis direction and in the Y axis direction (see FIG. 1). With this conventional arrangement, the asymmetric illuminating optical system achieves different magnifications on the X track and on the Y track and allows the CP aperture, which shapes the beam, to be isotropically irradiated with the beam. This linear electrode has been realized with an electron gun made of LaB₆ or the like. However, if the LaB₆ electron gun used in the prior art is used with an electron line source with a large energy distribution, the level of chromatic aberration may increase to degrade resolution. Further, disadvantageously, no linear type field emission electron guns with small energy distributions have been realized yet.

FIG. 3 is a partial schematic diagram of the electron beam drawing apparatus illustrating the asymmetric illuminating optical system of this embodiment. The X track 4 and Y track 5 of the electron beam emitted by the electron gun 2 are symmetric. Subsequently, the asymmetric illuminating optical system 46 (including CQL1;6, CQL2;7, CQL3;8, and CQL4;9) isotropically illuminates the first shaping aperture 10. The X track 4 and Y track 5 of the electron beam are configured so that at this time, the crossover between the X track 4 and the optical axis 1 (X crossover 40) is closer to the electron gun 2 relative to the first shaping aperture 10, while the crossover between the Y track 5 and the optical axis 1 (Y crossover 41) is closer to the wafer 29 relative to the first shaping aperture 10. Further, the tracks are adjusted so that the respective crossovers are at an equal distance (=d) from the shaping aperture 10 and so that the contraction rate of the electron beam from the electron gun 2 is equivalent at both crossovers.

The same positional relationship for the crossovers also applies to the second shaping aperture (CP aperture). That is, as shown in FIG. 4, the X track 4 and Y track 5 of the electron beam are configured so that the crossover between the X track 4 and the optical axis 1 (X crossover (not shown)) is closer to the electron gun 2 relative to the second shaping aperture 19, while the crossover between the Y track 5 and the optical axis 1 (Y crossover (not shown)) is closer to the wafer 29 relative to the second shaping aperture 19. Further, the tracks are adjusted so that the respective crossovers are at an equal distance from the second shaping aperture 19 and so that the contraction rate of the electron beam from the electron gun 2 is equivalent at both crossovers.

Now, a specific adjusting method will be described. Lens voltage values determined in designing the electronic optical system are set for the lenses 6, 7, and 8 of the asymmetric illumination system. The use of electrostatic lenses avoids hysteresis that may occur with lenses utilizing magnetic fields. Consequently, optical conditions are set so as to attain high reproducibility.

Then, a first shaping aperture alignment coil 11 is used to polarize and scan the electron beam 3 in the X and Y directions. At this time, the magnitude of the electron beam 3 applied to the first shaping aperture can be determined using, as a signal, electrons passing through the opening of the first shaping aperture 10, e.g. electrons flowing into the underlying CP aperture 19. The lenses of the asymmetric illuminating optical system are set so that at this time, an area irradiated with the electron beam 3 in the X direction is as large as an area irradiated with the electron beam 3 in the Y direction.

Then, the lenses OQL1;26 and OQL2;27 are regulated so as to minimize the resolution. The resolution is obtained by using the shaped electron beam 3 to scan the mark installed on the mark table 31, e.g. the dot of size about 0.2 μm which is made of tungsten and allowing the detector 28 such as an MCP to detect secondarily generated electrons.

The mark table 31 is movable in the vertical direction. Thus, variations in the resolutions of X track 4 and Y track 5 of the electron beam 3 are determined by moving the mark table 31 in the vertical direction from the position at which the resolution is minimized. For example, for the X direction, a variation in resolution is determined by moving the mark table 31 upward. For the Y direction, a variation in resolution is determined by moving the mark table 31 downward. The asymmetric illuminating optical system lenses are set so that the variations in resolutions are the same.

The optical system regulated as described above constitutes an asymmetric illuminating optical system before and after the first shaping aperture 10 but provides isotropic illumination on the first shaping aperture 10 in the X and Y directions. Subsequently, as shown in FIG. 4, an aperture image of the electron beam shaped by the first aperture 10 is formed on the CP aperture 19 at a contraction rate of 1 by the projecting quadrupole system (PQL1;14, PQL2;15, PQL3;17, and PQL4;18), with the illumination conditions saved in the image.

The X track 4 and Y track 5 of the electron beam are asymmetrically incident on the reducing quadrupole lenses (RQL;22 and RQL2;23), located between the CP aperture 19 and the wafer 29, where beam blurs may be caused by the Coulomb effect. Therefore, the effects of Coulomb repulsion can be weakened. As shown above, this embodiment is characterized in that the X crossover 40 between the optical axis 1 and the X track 4 of the electron beam emitted by the electron gun 2 is located above the first shaping aperture 10, while the Y crossover 41 between the optical axis 1 and the Y track 5 of the electron beam 3 is located below the first shaping aperture 10 and in that in particular, the illuminating optical system is regulated so that the X and Y crossovers are located at the equal distance (d) from the shaping aperture 10 and so that the projecting magnification of the beam from the electron gun 2 is the same at both crossovers. Thus, an optical system is realized which enables an electron gun with a fixed aspect ratio to isotropically illuminate the CP aperture and which can weaken the Coulomb effect. As a result, a field emission electron gun can be used to enable the use of the electron beam 3 with reduced variations in emitted energy distribution. Further, an electron beam drawing apparatus is provided which reduces the level of chromatic aberration while increasing the resolution.

In the embodiments, the electron beam drawing apparatus has been described which uses the two shaping apertures including the CP aperture. However, of course, the present invention is applicable to an electron beam drawing apparatus using a shaping aperture consisting only of a CP aperture.

The electron beam drawing apparatus described above in the embodiments and other sections regulates the lenses by executing a step calculating lens set values so that the crossover between the X track of the electron beam and the optical axis is located above the shaping aperture, while the crossover between the Y track of the electron beam and the optical axis is located below the shaping aperture and so that the distance from the shaping aperture to the crossover between the X track and the optical axis is equal to the distance from the shaping aperture to the crossover between the Y track and the optical axis; and setting the lenses of the asymmetric illuminating optical system on the basis of the lens set values, or determining lens values using means for determining an area of the shaping aperture irradiated with the electron beam and means for determining the angle of aperture of the electron beam applied to the shaping aperture; and fine-tuning the determined lens values to set the lenses of the asymmetric illuminating optical system. Then, a semiconductor wafer such as silicon on which a film is formed with a resist applied to the surface of the film is placed on the electron beam drawing apparatus set to have the predetermined lens set values. The resist applied to the semiconductor wafer placed in the apparatus is irradiated with an electron beam in a predetermined pattern by electron beam drawing apparatus.

Then, the resist on the semiconductor wafer which has been irradiated with the electron beam is developed and patterned to form a mask. This mask is used to etch and pattern the film such as a polysilicon film or silicon oxide film formed on the semiconductor wafer. Subsequently, the semiconductor wafer is post-processed to complete a semiconductor device.

The present invention is effective on a drawing apparatus using an asymmetric illuminating optical system and a low-acceleration electron beam.

Thus, according to the present invention, an optical system is realized which enables an electron gun with a fixed aspect ratio to isotropically illuminate the CP aperture and which can weaken the Coulomb effect. Consequently, a field emission electron gun can be used to reduce variations in emitted energy distribution and thus the amount of beam blurs caused by chromatic aberration. This serves to provide an electron beam drawing apparatus with a high resolution.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electron beam drawing apparatus comprising:
an asymmetric illuminating optical system to irradiate a predetermined illuminated area with an electron beam emitted by an electron beam source, at a predetermined current density;
a shaping aperture which shapes the electron beam into a predetermined form;
a reducing lens to form the electron beam shaped by the shaping aperture, into an image on a sample; and
an objective lens to form the electron beam passing through the reducing lens, into an image on the sample, and
wherein in spaces located above and below the shaping aperture, either a first crossover between an X track of the electron beam and an optical axis or a second crossover between a Y track of the electron beam and the optical axis is present in the space above the shaping aperture, while the other crossover is present in the space below the shaping aperture.

2. An electron beam drawing apparatus according to claim 1, wherein a distance from the shaping aperture to the first crossover is substantially equal to a distance between the shaping aperture and the second crossover.

3. An electron beam drawing apparatus according to claim 1, wherein a magnification of the electron beam source on the X track at the first crossover is substantially equal to a magnification of the electron beam source on the Y track at the second crossover.

4. An electron beam drawing apparatus according to claim 1, wherein the asymmetric illuminating optical system comprises at least four even-number multipole lenses.

5. An electron beam drawing apparatus according to claim 4, wherein the multipole lenses are of an electrostatic type.

6. An electron beam drawing apparatus according to claim 1, wherein the reducing lens and the objective lens each comprise at least two multipole lenses.

7. An electron beam drawing apparatus comprising:
an asymmetric illuminating optical system to irradiate a predetermined illuminated area with an electron beam emitted by an electron beam source, at a predetermined current density;
a first and second shaping apertures which shape the electron beam into a predetermined form;
a projecting lens which projects an aperture image of the first shaping aperture on the second shaping aperture;
a reducing lens to form the electron beam shaped by the first and second shaping apertures, into an image on a sample; and
an objective lens to form the electron beam passing through the reducing lens, into an image on the sample, and
wherein in spaces located above and below the first shaping aperture, either a first crossover between an X track of the electron beam and an optical axis or a second crossover between a Y track of the electron beam and the optical axis is present in the space above the shaping aperture, while the other crossover is present in the space below the shaping aperture, and
wherein in spaces located above and below the second shaping aperture, either a third crossover between an X track of the electron beam and an optical axis or a fourth crossover between a Y track of the electron beam and the optical axis is present in the space above the shaping aperture, while the other crossover is present in the space below the shaping aperture.

8. An electron beam drawing apparatus according to claim 7, wherein a distance from the first shaping aperture to the first crossover is substantially equal to a distance between the first shaping aperture and the second crossover.

9. An electron beam drawing apparatus according to claim 7, wherein a distance from the second shaping aperture to the third crossover is substantially equal to a distance between the second shaping aperture and the fourth crossover.

10. An electron beam drawing apparatus according to claim 7, wherein a magnification of the electron beam source on the X track at the first crossover is substantially equal to a magnification of the electron beam source on the Y track at the second crossover.

11. An electron beam drawing apparatus according to claim 7, wherein the asymmetric illuminating optical system comprises at least four even-number multipole lenses.

12. An electron beam drawing apparatus according to claim 11, wherein the multipole lenses are of an electrostatic type.

13. An electron beam drawing apparatus according to claim 7, wherein the projecting lens, the reducing lens, and the objective lens each comprise at least two multipole lenses.

14. A method of adjusting an electron beam in an electron beam drawing apparatus having an asymmetric illuminating optical system to irradiate a predetermined illuminated area with an electron beam emitted by an electron beam source, a shaping aperture to shape the electron beam into a predetermined form, and lenses to form the electron beam into an image on a sample, the method comprising:
calculating lens set values so that in spaces located above and below the shaping aperture, either a first crossover between an X track of the electron beam and an optical axis or a second crossover between a Y track of the electron beam and the optical axis is present in the space above the shaping aperture, while the other crossover is present in the space below the shaping aperture; and
setting positions of lenses constituting the asymmetric illuminating optical system on the basis of the lens set values.

15. An adjusting method according to claim 14, wherein the lens set values are set so that a distance from the shaping aperture to the first crossover is substantially equal to a distance between the shaping aperture and the second crossover.

16. An adjusting method according to claim 14, wherein the lens set values are determined using means for determining an area of the shaping aperture which is irradiated with an electron beam and means for determining the angle of aperture of an electron beam applied to the shaping aperture, and
wherein the lens set values are fine-tuned, and on the basis of the lens set values, the positions of the lenses constituting the asymmetric illuminating optical system are set.

17. An electron beam drawing method comprising:
providing a semiconductor wafer to which a resist has been applied;
regulating an electron beam drawing apparatus using lens set values determined by the adjusting method according to claim 14; and
using the electron beam drawing apparatus to irradiate the resist with an electron beam.
